(19) United States
(12) Patent Application Publication
(10) Pub. No.: US 2008/0012820 A1
(43) Pub. Date: Jan. 17, 2008

(54) System and method for achieving desired operation illumination condition for light emitters

(76) Inventors: Chun-Chieh Yang, Hsinchu (TW); Hong-Xi Cao, Hsinchu (TW); Kun-Chieh Chang, Hsinchu (TW); Zhi-Xian Huang, Hsinchu (TW); Cheng-Fa Chen, Hsinchu (TW); Ji-Bin Horng, Hsinchu (TW)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/580,843

(22) Filed: Oct. 16, 2006

Related U.S. Application Data
(60) Provisional application No. 60/819,651, filed on Jul. 11, 2006.

(51) Int. Cl. G09G 3/36

(52) U.S. Cl. 345/102

(57) ABSTRACT

A method and a system for achieving a desired operation illumination condition for a plurality of light emitters are provided. The light emitters are divided into mutually distinctive groups. The groups of light emitters are sequentially activated while maintaining the rest of groups of the light emitters in an inactivated state. In this manner, the illumination condition of each group of light emitters are detected, so as to adjust a driving condition for the light emitters, thereby producing a light source with uniformly distributed white light spectra, and a homogeneous intensity distribution over the entire region of the light source.

### RELATED APPLICATIONS

This application claims the benefit of priority from U.S. Provisional Application No. 60/819,651, filed Jul. 11, 2006, the entirety of which is expressly incorporated herein by reference in its entirety.

### TECHNICAL FIELD

The present invention relates generally to a backlight module for flat panel displays and a method for adjusting the backlight module. More particularly, the present invention relates to a system and a method for adjusting the color balance of a backlight module.

### BACKGROUND INFORMATION

Flat panel displays, such as liquid crystal displays (LCDs), have gained popularity over the conventional cathode ray tube (CRT) displays in recent years, primarily due to their slimness. However, in contrast to the CRT displays, an LCD requires an additional light source to illuminate the image pixels displayed on the LCD.

Currently, a cold-cathode fluorescent lamp (CCFL) is commonly used as the light source for color LCDs. The CCFL emits a uniformly distributed white-colored light by exciting the fluorescent powder coated on the inner surface of the CCFL tube. However, the color saturation of CCFL can reach only up to approximately 70% of the National Television System Committee (NTSC) standard. Therefore, many high-end users favor a plasma display panel (PDP) TV, which produces a better color effect than an LCD TV.

Recently, light emitting diodes (LEDs) have been used as a light source for LCD TVs. By using LEDs as a light source, the color saturation of an LCD TV can reach up to about 120% of the NTSC standard. In addition, the advantages of LEDs include a longer life span of more than a hundred thousand hours, and a faster reaction time shorter than a few tens of nano-seconds. Moreover, the European Union has particularly restricted the amount of certain hazardous substances used in electrical and electronic products, e.g. mercury in CCFL. LEDs, therefore, will gradually replace the CCFL to serve as the primary light source for LCD TVs.

In order for LEDs to properly provide a white light source of a backlight module with uniformly distributed spectra, LEDs of different colors, such as red, green, and blue, are used. One problem of using LEDs of different colors to achieve a white light source is the difficulty of maintaining a color balance of the source. This difficulty arises from the fact that the brightness of the LEDs decays as they age. In addition, the decay rates are different for LEDs of different colors. The decay rates also may depend on other factors, such as the temperature of the LEDs. Accordingly, the color spectra generated by a multi-color LED light source will shift over the lifetime and the working temperature of the backlight module.

In order to maintain the color balance, one or more color detectors are disposed in the backlight module. The color detector monitors the change of brightness and the resultant colors of the light emitted from the LEDs. The detected brightness and color are then processed and fed back into the driving circuit to properly control the LED light source. The feedback process indeed reduces the overall color shift of the LED light source. However, such a feedback process cannot ensure the color balance and the homogeneity of color spectra of multiple LEDs at certain local regions.

U.S. Pat. No. 6,448,550 (hereafter “the '550 patent”) discloses a method and an apparatus for measuring spectral content of LED light source and control thereof. In the '550 patent, a plurality of photosensors is disposed in different regions of the backlight module for measuring spectral content of ambient light output from LEDs of different colors. The measured spectral content is then used to control the illumination level of individual LEDs by varying the current sent to LEDs of different colors. The '550 patent enables adjustments of color balance of LEDs at each local region. However, the method of the '550 patent can have limited precision of control of the color balance of each local region due to the interference between light emitted by LEDs of different regions.

U.S. Pat. No. 6,753,661 (hereafter “the '661 patent”) discloses an apparatus for backlighting an electronic display with LEDs to control color levels by means of feedback control through a microprocessor. In the '661 patent, a plurality of photodiodes with filters is disposed in the backlighting apparatus for detecting the output level of each color emitted from the LEDs. The detected results are then fed back into the driving circuit to adjust the color balance of the LED light source. However, methods and apparatus of the '661 patent may also exhibit limited precision of control of the color balance of each local region due to the interference between light emitted from different regions.

U.S. Pat. No. 6,445,139 (hereafter “the '139 patent”), U.S. Pat. No. 6,495,964 (hereafter “the '964 patent”), and U.S. Pat. No. 6,127,783 (hereafter “the '783 patent”) disclose a white light source including LEDs of a plurality of colors. The light output of each color is measured by turning off the LEDs not being measured in a sequence of time pulses. In the '139 patent, the '964 patent, and the '783 patent, only a single photodiode is provided for measuring the entire spectrum of the LED light source. Since these three patents measure light output of one color at a time, they also may exhibit limitation on precision of control of the color balance of each local region due to the interference between light emitted from different regions.

### SUMMARY

In one aspect, there is provided a system for achieving a desired operation illumination condition for each of a plurality of light emitters. The light emitters produce an illumination condition variable in accordance with a supplied driving condition. The system includes a driving circuit, an optical sensor, and a processing circuit. The driving circuit supplies an initial driving condition to the light emitters. The driving circuit also sequentially activates a selected one of the light emitters by supplying the selected light emitter with a calibration driving condition while maintaining the remainder of the light emitters in an inactivated state. The optical sensor is positioned to generate a detection signal corresponding to the illumination condition produced by the light emitters. The processing circuit is coupled to the optical sensor for receiving the detection signal. The processing circuit determines an adjustment factor by comparing the detection signal produced by the light emitters with a calibration signal corresponding to a calibration illumination condition. The processing circuit is further coupled to the driving circuit for supplying to the driving circuit a modified driving condition, which includes the initial driving condition modified by the adjustment factor, thereby driving the light emitters with the modified driving condition.

In another aspect, there is provided a method for achieving a desired operation illumination condition for a plurality of light emitters. The method includes the following steps:

(a) operating the light emitters by supplying an initial driving condition;

(b) activating a selected one of the light emitters by supplying the selected light emitter with a calibration driving condition while maintaining the remainder of the light emitters in an inactivated state;

(c) detecting the illumination condition produced by the selected light emitter;

(d) determining an adjustment factor for the selected light emitter by comparing the detected illumination condition with a calibration illumination condition;

(e) sequentially repeating steps (b)-(d) by individually selecting the remainder of the light emitters; and

(f) respectively supplying the light emitters with a modified driving condition comprising the initial driving condition modified by the adjustment factor.

It is to be understood that both the foregoing general description and the following detailed description are exemplary and explanatory only, and are not restrictive of the invention, as claimed.

### BRIEF DESCRIPTION OF THE DRAWINGS

In the drawings:

FIG. 1 schematically illustrates a system for achieving desired operation illumination condition for light emitters, in one embodiment consistent with the present invention.

FIG. 2 is a time sequence diagram illustrating an initial driving condition and a calibration driving condition for the light emitters, in one embodiment consistent with the present invention.

FIG. 3A illustrates an enlarged view of the dashed circle A of FIG. 2.

FIG. 3B illustrates an enlarged view of the dashed circle B of FIG. 2.

FIG. 3C illustrates an enlarged view of the dashed circle C of FIG. 2.

FIG. 4 is a time sequence diagram illustrating an initial driving condition and a calibration driving condition for the light emitters, in accordance with another embodiment of the present invention.

FIG. 5 schematically illustrates a system for achieving desired operation illumination condition for light emitters, in one embodiment consistent with the present invention.

FIG. 6 is a flow diagram illustrating a method for achieving desired operation illumination condition for light emitters, in accordance with one embodiment of the present invention.

### DETAILED DESCRIPTION

Reference will now be made in detail to embodiments consistent with the invention, examples of which are illustrated in the accompanying drawings. Wherever possible, the same reference numbers will be used throughout the drawings to refer to the same or like parts.

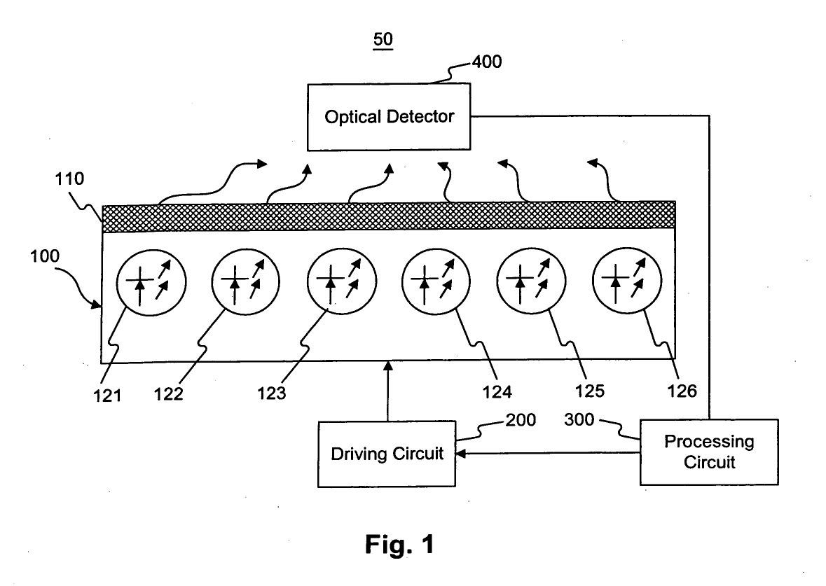

Referring now to FIG. 1, there is shown a system 50 for achieving a desired operation illumination condition for each of a plurality of light emitters. Of course, a complete backlight module may include a plurality of systems 50.

As shown, system 50 includes a light emitting member 100, a driving circuit 200 coupled to light emitting member 100, a processing circuit 300 coupled to driving circuit 200, and an optical sensor 400 coupled to processing circuit 300. Light emitting member 100 further includes a common substrate 120, upon which is disposed a plurality of light emitters, such as LEDs 121, 122, 123, 124, 125, 126, and an optical diffusion film 110. Optical diffusion film 110 is disposed on common substrate 120, and between optical sensor 400 and light emitters 121, 122, 123, 124, 125, 126. Optical diffusion film 110 mixes the optical outputs of light emitters 121, 122, 123, 124, 125, 126 for obtaining a white light of uniformly distributed spectra.

The light emitters of system 50 are illustrated as light emitting diodes (LEDs), and will henceforth be referred to as LEDs. However, other types of light emitters may be employed.

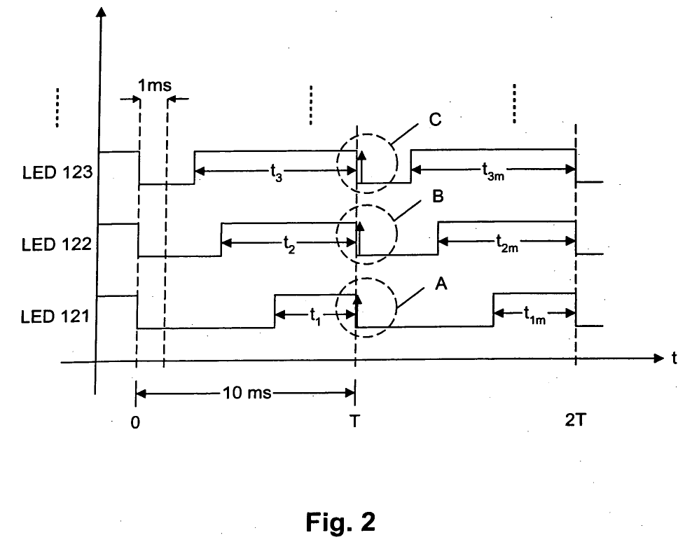

Referring to FIG. 1 together with FIG. 2, driving circuit 200 supplies an initial driving condition to LEDs 121, 122, 123, 124, 125, 126 for producing from each of LEDs 121, 122, 123, 124, 125, 126 an illumination condition variable in accordance with the supplied initial driving condition. In one embodiment, the initial driving condition comprises a pulse width modulated (PWM) current having an initial pulse width. The initial driving condition comprises a current of constant amplitude. However, other types of initial driving condition, such as a current of varying amplitude, may be employed.

As illustrated in FIG. 2, for example, driving circuit 200 supplies a PWM current of period T and an initial pulse width t₁ to LED 121. Driving circuit 200 also supplies a PWM current of period T and an initial pulse width t₂ to LED 122. Similarly, driving circuit 200 supplies a PWM current of period T and an initial pulse width t₃ to LED 123, and so on. In one embodiment, the period T of PWM current is substantially equal to 10 ms. By supplying the initial driving condition to LEDs 121, 122, 123, 124, 125, 126, a desired operation illumination condition for each of these LEDs is achieved in accordance with the luminance perceived by human eyes. The desired operation illumination condition, in this embodiment, consists of the illumination of white light of uniformly distributed spectra, and the homogeneity of the white light of system 50 in different local regions.

As discussed earlier, the optical output of light emitters may vary according to several factors. For example, the optical output of LEDs decays during the lifetime of light emitters. The decay rates depend on the particular type of LED, as well as the working temperature of LEDs. For this reason, the operation illumination condition may shift over time and may no longer constitute the desired operation illumination condition during the lifetime of the light emitters. Such a shift is perceivable by human eyes. Therefore, in order for LEDs to maintain the desired operation illumination condition, initial driving condition must be modified, either manually or periodically, in accordance with decay rates. In addition, in order to precisely control the color balance of LEDs disposed in each local region, LEDs should be adjusted individually.

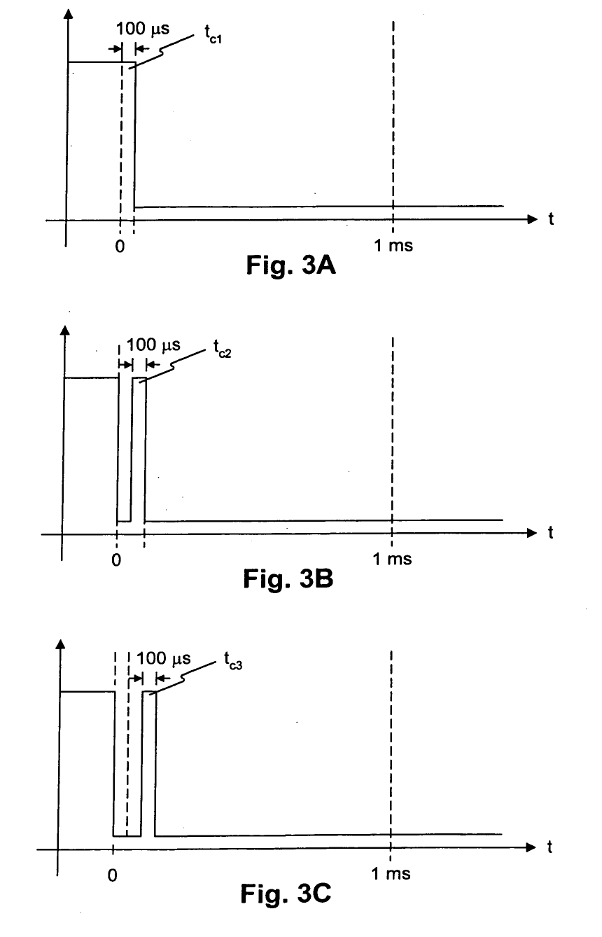

Referring now to FIG. 2, there is shown a time sequence diagram illustrating an initial driving condition and a calibration driving condition for each of light emitters, in accordance with one embodiment of the present invention. Reference is also made to FIG. 3A, 3B, 3C, wherein enlarged views of the dashed circles A, B, C of FIG. 2 are illustrated, respectively. In order to adjust the illumination condition of each LED, one of LEDs 121-126 is selectively activated while maintaining the remainder of these LEDs in an inactivated state.

As shown in FIG. 2 and FIG. 3A, driving circuit 200 first supplies the calibration driving condition to LED 121 by activating LED 121 for a time period t_{c1}, outside of the initial pulse width t₁. In this particular embodiment, the calibration driving condition includes a first electrical signal having a pulse width of 100 μsec, which is represented by an erected arrow in the dashed circle A of FIG. 2, and the label t_{c1} in FIG. 3A. It is understood that the pulse width may range from about 50 to about 100 μsec.

As shown in FIG. 3A, the first electrical signal is supplied to LED 121 for a period, such as 100 μsec, which is less than a flicker-preventable time. That is, human eye can perceive a flicker if a light emitter is activated for at least a certain time period. However, the eye does not perceive a flicker if the light emitter is activated for less than the certain time period, which is called the “flicker-preventable time.” When the calibration driving condition is supplied to LED 121, the remainder of LEDs 122-126 are maintained in an inactivated state.

As shown in FIG. 1, optical sensor 400 measures the illumination condition produced by the selectively activated LED 121, and generates a detection signal D₁ corresponding to the measured illumination condition. In this particular embodiment, optical sensor 400 may be a commercially available photo detector (e.g. a type PDI-M301 manufactured by Advanced Photonix, Inc. or S7329-01 manufactured by Hamamatsu). The illumination condition, in one embodiment, includes an illumination level I. Detection signal D₁, in this particular embodiment, is directly proportional to illumination level I₁.

Processing circuit 300 then receives detection signal D₁ from optical sensor 400. In this particular embodiment, detection signal D₁ is compared with a calibration signal D₂, which corresponds to a calibration illumination condition comprising a calibration illumination level I₂. The signal produced by optical sensor 400, in this particular embodiment, is directly proportional to the illumination level incident thereon. However, other functions relating incident illumination and produced signal my be used. The proportionality constant between detection signal D₁ and illumination level I₁ is substantial equal to the proportionality constant between calibration signal D₂ and calibration illumination level I₂. Moreover, calibration illumination level I₂ is substantially equal to an illumination intensity produced by the selected LED under specified condition, such as immediately after manufacture the initial driving condition, and at room temperature. Processing circuit 300 further determines an adjustment factor for LED 121 by comparing the detected illumination condition and the calibration illumination condition. In one embodiment, the adjustment factor is a ratio of calibration illumination level I₂ to illumination level I₁, i.e. I₂/I₁.

Processing circuit 300 then supplies a modified driving condition to driving circuit 200, thereby driving LED 121 with the modified driving condition. In one embodiment, the modified driving condition comprises a PWM current with a pulse width t₁ₘ. The modified pulse width t₁ₘ is substantially equal to the initial pulse width t₁ modified by the adjustment factor. More specifically, the modified pulse width t₁ₘ is equal to the initial pulse width t₁ multiplied by the adjustment factor I₂/I₁. Therefore, LED 121 is now driven by a PWM current having a modified pulse width t₁ₘ, and a desired operation illumination condition for LED 121 is achieved.

Referring now to FIG. 3B together with FIG. 1 and FIG. 2, driving circuit 200 subsequently supplies the calibration driving condition to LED 122 activating LED 122 for a time period t_{c2}, outside of initial activation period t₂. In this particular embodiment, the calibration driving condition includes a second electrical signal having a pulse width of 100 μsec, which is represented by an erected arrow in the dashed circle B of FIG. 2, and the label t_{c2} in FIG. 3B.

In a similar manner, as shown in FIG. 3B, the second electrical signal is supplied to LED 122 for a period of 100 μsec, i.e. less than the flicker-preventable time. When the calibration driving condition is supplied to LED 122, the remainder of LEDs 121, 123-126 are maintained in an inactivated state.

The optical sensor 400 measures the illumination condition produced by the selectively activated LED 122, and generates a detection signal D₁ corresponding to the measured illumination condition.

Processing circuit 300 then receives detection signal D₁ from optical sensor 400. Detection signal D₁ is compared with a calibration signal D₂, which corresponds to a calibration illumination condition comprising a calibration illumination level I₂.

Processing circuit 300 then determines an adjustment factor for LED 122 by comparing the detected illumination condition and the calibration illumination condition. Processing circuit 300 then supplies a modified driving condition to driving circuit 200, thereby driving LED 122 with the modified driving condition. Therefore, LED 122 is now driven by a PWM current having a modified pulse width t₂ₘ, and a desired operation illumination condition for LED 122 is achieved.

Referring now to FIG. 3C together with FIG. 1 and FIG. 2, driving circuit 200 subsequently supplies the calibration driving condition to LED 123 activating LED 123 for a time period t_{c3}, outside of initial activation period t₃. In this particular embodiment, the calibration driving condition includes a second electrical signal having a pulse width of 100 μsec, which is represented by an erected arrow in the dashed circle C of FIG. 2, and the label t_{c3} in FIG. 3C.

In a similar manner, as shown in FIG. 3C, the third electrical signal is supplied to LED 123 for a period of 100 μsec, i.e. less than the flicker-preventable time. When the calibration driving condition is supplied to LED 123, the remainder of LEDs 121-122, 124-126 are maintained in an inactivated state.

Optical sensor 400 measures the illumination condition produced by selectively activated LED 123, and generates a detection signal D₁ corresponding to the measured illumination condition.

Processing circuit 300 then receives detection signal D₁ from optical sensor 400. Detection signal D₁ is compared with a calibration signal D₂, which corresponds to a calibration illumination condition comprising a calibration illumination level I₂.

Processing circuit 300 then determines an adjustment factor for LED 123 by comparing the detected illumination condition and the calibration illumination condition. Processing circuit 300 then supplies a modified driving condition to driving circuit 200, thereby driving LED 123 with the modified driving condition. Therefore, LED 123 is now driven by a PWM current having a modified pulse width t₃ₘ, and a desired operation illumination condition for LED 123 is achieved.

The remaining LEDs of backlight module may be processed in a similar manner.

By sequentially activating a selected one of LEDs while maintaining the remainders of the LEDs in an inactivated state until all of the LEDs are adjusted, the light emitting member 100 can thus achieve the desired operation illumination condition, thereby providing a uniformly distributed white light source for a plat panel display.

Referring again to FIG. 2, in this particular embodiment, the calibration signals are supplied to LEDs during the 1 ms slot within the period T of PWM currents, such that the calibration signals would not affect the driving condition of PWM current. Since the flicker-preventable time is equal to 100 μsec, in this embodiment, a maximum ten LEDs may be adjusted within the same period T of PWM current. In case that the light emitting member 100 includes more than twenty LEDs, it is then necessary to divide the LEDs in groups and adjust different groups of LEDs in different period T of PWM current. However, other embodiments may not be so limited.

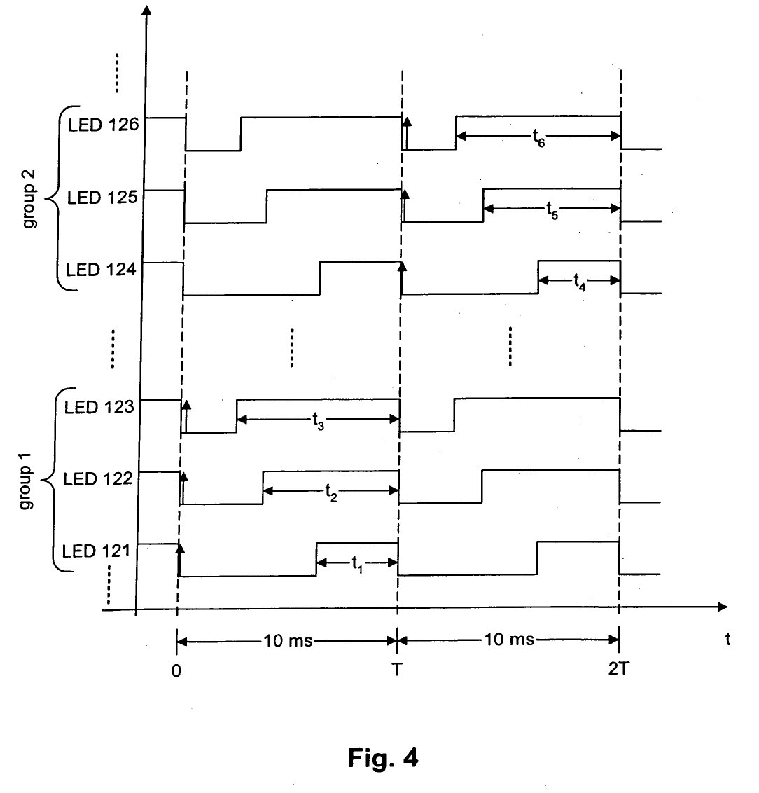

Referring to FIG. 4, there is provided a time sequence diagram of another embodiment illustrating an initial driving condition and a calibration driving condition for each of the light emitters. As shown, LEDs 121, 122, 123, 124, 125, 126, in this embodiment, are divided into a first group and a second group. The first group includes LED 121, LED 122, and LED 123; while the second group includes LED 124, LED 125, and LED 126. The electrical signals for selectively activating one of the LEDs while maintaining the remainder of LEDs in an inactivated state are supplied to the first group of LEDs 121, 122, 123 during the first period (from 0 to T) of the PWM current. Accordingly, the first group of LEDs 121, 122, 123 is adjusted during the first period of PWM current. In addition, the electrical signals are supplied to the second group of LEDs during the second period (from T to 2 T) of the PWM current. Accordingly, the second group of LEDs 124, 125, 126 is adjusted during the second period of PWM current.

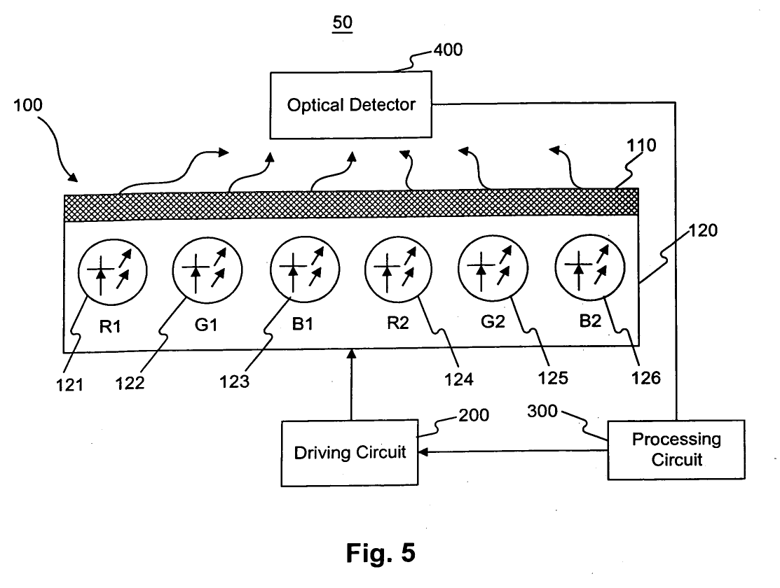

Reference is now made to FIG. 5, which illustrates another embodiment of system 50 for achieving desired operation illumination condition for light emitters. As shown, system 50 includes a light emitting member 100, a driving circuit 200 coupled to the light emitting member 100, a processing circuit 300 coupled to the driving circuit 200, and an optical sensor 400 coupled to the processing circuit 300. Light emitting member 100 further includes a common substrate 120, wherein a plurality of light emitters 121, 122, 123, 124, 125, 126 is disposed thereon, and an optical diffusion film 110 disposed on the common substrate 120. In this particular embodiment, LED 121 and LED 124 emit light of red color; LED 122 and LED 125 emit light of green color; and LED 123 and LED 126 emit light of blue color. In this particular embodiment, optical sensor 400 may be a commercially available RGB color sensor, such as manufactured by Hamamatsu Co.

In this particular embodiment, the plurality of light emitters 121, 122, 123, 124, 125, 126 is divided into a first group and a second group. As shown in FIG. 5, the first group includes a LED 121 of red color, a LED 122 of green color, and a LED 123 of blue color; while the second group includes a LED 124 of red color, a LED 125 of green color, and a LED of blue color. Of course, in other applications, more than two groups may be provided.

Driving circuit 200 first supplies an initial driving condition to light emitters 121, 122, 123, 124, 125, 126, and then sequentially activates a selected group of light emitters, e.g. the first group, while maintaining the remainder groups of light emitters, e.g. the second group, in an inactivated state.

Optical sensor 400 then generates a detection signal in response to the illumination condition produced by the selected group of light emitters. In this particular embodiment, the illumination condition includes an illumination level for light of different colors.

Processing circuit 300 then receives the detection signal from optical sensor 400, and determines an adjustment factor by comparing the detection signal with a calibration signal, which corresponds to a calibration illumination condition. The calibration illumination condition includes the illumination intensities for light of different colors that the selected group of LEDs is supposed to achieve.

Driving circuit 200 then receives the adjustment factor from processing circuit 300, and supplies a modified driving condition, which is the initial driving condition modified by the adjustment factor, to the selected group of light emitters, thereby driving the light emitters with the modified driving condition.

Therefore, by sequentially adjusting the driving condition of each selected group of LEDs, light emitting member 100 then provides a light source of balanced color and a light source of homogeneous color distribution at all regions.

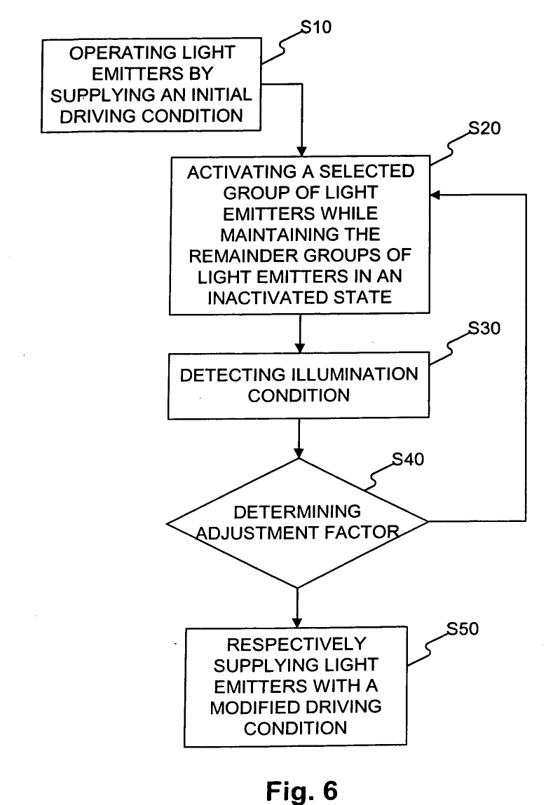

Referring now to FIG. 6, there is provided a flow diagram of a method for achieving desired operation illumination condition for light emitters, in accordance with one embodiment of the present invention.

In step S10, the light emitters are operated by supplying an initial driving condition. The initial driving condition, in one embodiment, includes a PWM current having an initial pulse width tᵢ for each of the light emitters. Of course, other initial driving conditions could be employed, such as an amplitude-modulated direct current.

In step S20, a selected group of the light emitters is activated by supplying the selected group of light emitters with a calibration driving condition while maintaining the remainder of the light emitters in an inactivated state. In this particular embodiment, the light emitters are divided into a plurality of mutually exclusive groups. The selected group of light emitters is activated during a time period outside of the initial pulse width of the PWM current. In one embodiment, the selected group of light emitters includes a single LED. In another embodiment, the selected group of light emitters includes a red LED, a green LED, and a blue LED. The calibration driving condition includes an electrical signal provided to the selected group of light emitters for a period of time less than a flicker-preventable time. In other words, the electrical signal is provided to the selected light emitters without causing human eyes to observe any flicker. This flicker-preventable time, in one embodiment, is equal to or less than 50 μsec.

In step S30, the illumination condition produced by the selected light emitter is detected. The illumination condition, in one embodiment, includes an illumination intensity I_{d}, or an illumination level I_{d}.

In step S40, an adjustment factor is determined for the selected group of light emitters by comparing the detected illumination condition with a calibration illumination condition. In one embodiment, the calibration illumination condition includes a calibration illumination intensity I_{c}, or an calibration illumination level I_{c}. In one embodiment, the adjustment factor is a ratio of the calibration illumination level I_{c} to the illumination level I_{d}, i.e. I_{c}/I_{d}.

Next, steps S20 to S40 are sequentially repeated by individually selecting the remainder groups of light emitters until the adjustment factor for all light emitters has been determined.

In step S50, the light emitters are respectively supplied with a modified driving condition. In one embodiment, the modified driving condition includes a modified pulse width t_{f}, which is the initial pulse width tᵢ modified by the adjustment factor. More specifically, the modified pulse width t_{f} is substantially equal to the adjustment factor (i.e. I_{c}/I_{d}) multiplying the initial pulse width tᵢ.

The method for achieving a desired operation illumination condition for a plurality of light emitters, in accordance with one embodiment of the present invention, has been described in detail. However, it is appreciated that other embodiments are also possible to carry out the invented method. For example, step S50 does not need to wait until the adjustment factor of all light emitters is determined by sequentially repeating the steps S20 to S40. In other words, It is possible to carry out step S50 first right after the adjustment factor for each selected group of light emitters is determined, and sequentially repeating steps S20 to S50 for determining the adjustment factor of other groups of light emitters.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for achieving a desired operation illumination condition for a plurality of light emitters, which, when activated, produce an illumination condition variable in accordance with a supplied driving condition, the method comprising:
(a) operating the light emitters by supplying an initial driving condition;
(b) activating a selected one of the light emitters by supplying the selected light emitter with a calibration driving condition while maintaining the remainder of the light emitters in an inactivated state;
(c) detecting the illumination condition produced by the selected light emitter;
(d) determining an adjustment factor for the selected light emitter by comparing the detected illumination condition with a calibration illumination condition;
(e) sequentially repeating steps (b)-(d) by individually selecting the remainder of the light emitters; and
(f) respectively supplying the light emitters with a modified driving condition comprising the initial driving condition modified by the adjustment factor.

2. The method as recited in claim 1, wherein the initial driving condition comprises a pulse width modulated current having an initial pulse width.

3. The method as recited in claim 2, wherein the selected light emitters are activated during a time period outside of the initial pulse width of the pulse width modulated current.

4. The method as recited in claim 2, wherein the illumination condition comprises a first illumination level of the selected light emitter.

5. The method as recited in claim 4, wherein the calibration illumination condition comprises a second illumination level of the selected light emitter.

6. The method as recited in claim 5, wherein the adjustment factor is the ratio of the second illumination level to the first illumination level.

7. The method as recited in claim 6, wherein the modified initial driving condition comprises a modified pulse width of the pulse width modulated current, the modified pulse width being substantially equal to the initial pulse width modified by the adjustment factor.

8. The method as recited in claim 1, wherein the calibration driving condition comprises an electrical signal provided to the light emitter for a period of time less than a flicker-preventable time.

9. The method as recited in claim 8, wherein the period of time is less than or equal to 100 μsec.

10. The method as recited in claim 1, wherein the initial driving condition comprises an amplitude of a direct current.

11. The method as recited in claim 1, wherein the light emitters comprise light emitting diodes of a plurality of colors.

12. A system for achieving a desired operation illumination condition for a plurality of light emitters, the light emitters producing an illumination condition variable in accordance with a supplied driving condition, the system comprising:
a driving circuit supplying an initial driving condition to the light emitters, the driving circuit also sequentially activating a selected one of the light emitters by supplying the selected light emitter with a calibration driving condition while maintaining the remainder of the light emitters in an inactivated state;
an optical sensor positioned so as to generate a detection signal corresponding to the illumination condition produced by the light emitters; and
an processing circuit coupled to the optical sensor for receiving the detection signal, the processing circuit determining an adjustment factor by comparing the detection signal produced by the light emitters with a calibration signal corresponding to a calibration illumination condition, the processing circuit further coupled to the driving circuit for supplying to the driving circuit a modified driving condition comprising the initial driving condition modified by the adjustment factor, thereby driving the light emitters with the modified driving condition.

13. The system as recited in claim 12, wherein the initial driving condition comprises a pulse width modulated current having an initial pulse width.

14. The system as recited in claim 13, wherein the selected light emitters are activated during a time period outside of the initial pulse width of the pulse width modulated current.

15. The system as recited in claim 13, wherein the illumination condition comprises a first illumination level of the selected light emitter.

16. The system as recited in claim 15, wherein the calibration illumination condition comprises a second illumination level of the selected light emitter.

17. The system as recited in claim 16, wherein the adjustment factor is the ratio of the second illumination level to the first illumination level.

18. The system as recited in claim 17, wherein the modified initial driving condition comprises a modified pulse width of the pulse width modulated current, the modified pulse width being substantially equal to the initial pulse width modified by the adjustment factor.

19. The system as recited in claim 12, wherein the calibration driving condition comprises an electrical signal provided to the light emitter for a period of time less than a flicker-preventable time.

20. The system as recited in claim 19, wherein the calibration driving condition period is less than or equal to 50 μsec.

21. The system as recited in claim 12, wherein the initial driving condition comprises an amplitude of a direct current.

22. The system as recited in claim 12, wherein the light emitters comprise light emitting diodes of a plurality of colors.

23. The system as recited in claim 12, further comprising an optical diffusion film disposed between the optical sensor and the light emitters.
